(19) United States
(12) Patent Application Publication
(10) Pub. No.: US 2005/0148325 A1
(43) Pub. Date: Jul. 7, 2005

(54) Method of providing service for user equipment and system

(76) Inventors: Toni Kopra, Vantaa (FI); Mikko Makipaa, Helsinki (FI); Akseli Anttila, Helsinki (FI)

Correspondence Address: CRAWFORD MAUNU PLLC, 1270 NORTHLAND DRIVE, SUITE 390, ST. PAUL, MN, 55120, US

(21) Appl. No.: 10/511,768

(22) PCT Filed: Apr. 14, 2003
(86) PCT No.: PCT/FI03/00286

(30) Foreign Application Priority Data
Apr. 22, 2002 (US) 10/126623
Jul. 1, 2002 (IB) 02/02537
Dec. 16, 2002 (US) 10/319475

(51) Int. Cl. H04M 3/00

(52) U.S. Cl. 455/420

(57) ABSTRACT

The invention is related to a method and a system of providing a service associated with a media stream for user equipment The system comprises a server connected to a communication network for providing the service using the radio interface of the communication network. The system further comprises a broadcast system for providing the media stream. Associating data for associating the media stream with the service is transmitted from the system to the user equipment. The associating data is received, and the system is configured to provide the user equipment with the service by using the associating data.

### FIELD

The invention relates to a method of providing service for user equipment and a system of providing a service for user equipment.

### BACKGROUND

Broadcasters, such as television and radio broadcasters, have taken steps forward to provide an audience with digital supplementary services, such as program information, news, weather information, competitions and other related content, in addition to a traditional media stream. The digital supplementary services are usually delivered to the audience over the Internet using the audiences' personal computers or other devices capable of connecting to the Internet.

More mobility is provided for the audience by user equipment of cellular telecommunication systems, which user equipment are equipped with a receiver, such as an FM radio, for receiving media streams broadcast by broadcasters. Broadcasters typically provide Internet services, which can be accessed by user equipment, such as one equipped with a WAP (Wireless Application Protocol), capable of connecting to such a service. In order to obtain the service needed, the user is required to navigate to the broadcaster's Internet site and select the right service. In order to inform the users about services available, the broadcasters usually promote their Internet address in actual television or radio broadcasts, or in other mass media.

There are, however, problems related to complexity in accessing a service by a user. The complexity arises from a need for advertising service addresses by the broadcasters and memorizing desired service addresses by the user. Furthermore, navigating a way through a complicated Internet web structure to the correct service address is laborious and time consuming. The complexity in accessing the service results in a high barrier to connect a user to a service and low ratings of the service.

### BRIEF DESCRIPTION OF THE INVENTION

An object of the invention is to provide an improved method and system of providing a user equipment with service. According a first aspect of the invention, there is provided a method of providing a service for user equipment of a cellular telecommunication system, the service being transmitted over a radio interface of a cellular telecommunication system, the user equipment comprising a user terminal for communicating in the cellular telecommunication system and a media receiver for receiving a media stream provided by a radio broadcast system, the method comprising: transmitting 302 associating data for associating a media stream with a service; receiving, in the user equipment, the associating data; and configuring a system comprising the cellular telecommunication system and the broadcast system to provide the user equipment with the service associated with the media stream by using the associating data.

According to another aspect of the invention, there is provided a system of providing a service for user equipment, comprising: a communication network of a cellular telecommunication system for providing the user equipment with mobile services; a broadcast system for providing the user equipment with a media stream; a user terminal, in the user equipment, for communicating in the cellular telecommunication system; and a media receiver, in the user equipment, for receiving the media stream, a server connected to the communication network for providing the user equipment with service associated with the media stream by using the radio interface of the cellular telecommunication system; an associating data source for providing the user equipment with associating data for associating the media stream with the service; the user equipment is configured to receive at least a portion of the associating data; and the system further comprises configuring means operationally connected to the user equipment and the server for configuring the system to provide the user equipment with the service associated with the media stream by using the associating data.

Preferred embodiments of the invention are described in the dependent claims.

The method and system of the invention provide several advantages. In an embodiment of the invention, the associating data received by the user equipment enables configuring the system to provide the user equipment with the service associated with the media stream such that the user's contribution in configuring the system is small. In an embodiment, the invention enables selecting between different media streams and associated services by using presets configured into the user equipment.

### LIST OF DRAWINGS

In the following, the invention will be described in greater detail with reference to the preferred embodiments and the accompanying drawings, in which

FIG. 1 shows an example of a structure of a system according to the invention,

FIG. 2 shows a second example of a structure of a system according to the invention,

FIG. 3 shows a first example of the methodology used by the system according to embodiments of the invention,

FIG. 4 shows a second example of the methodology used by the system according to embodiments of the invention, and

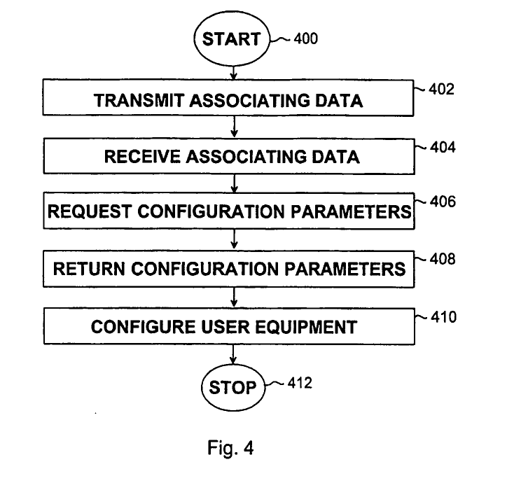

FIG. 5 shows another example of the methodology used by the system according to embodiments of the invention.

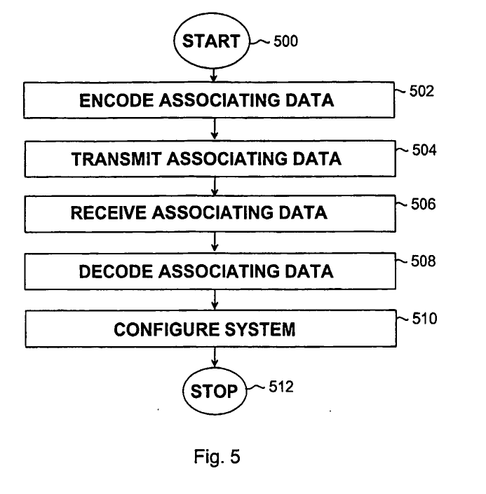

### DESCRIPTION OF EMBODIMENTS

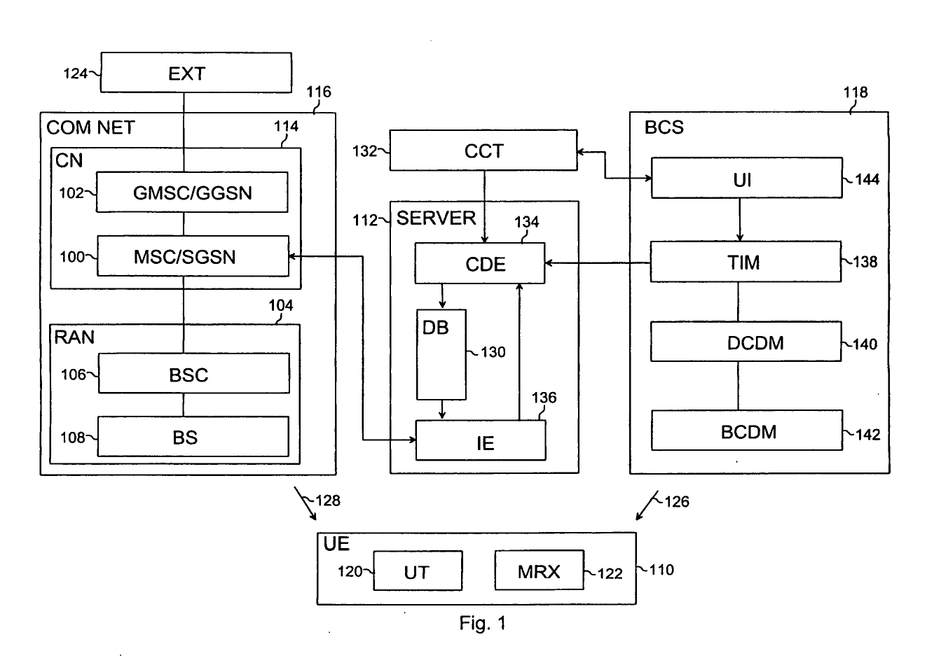

FIG. 1 illustrates an example of a simplified structure of a system according to an aspect of the invention. The system comprises a communication network 116 (COM NET) of a cellular telecommunications system, a broadcast system (BCS) 118, and user equipment (UE) 110 of the cellular telecommunications system.

The cellular telecommunications system is based on, for example, a GSM (Global System for Mobile Communications) radio access technology or WCDMA (Wideband Code Division Multiple Access) technology. The structure and function of cellular telecommunications systems are known to a person skilled in the art, and those network elements relevant to the invention will be described.

The communication network 116 provides the user equipment 110 with mobile services. The broadcast system 118 provides a media stream using, for example, a radio or television broadcast.

The communication network 116 may represent the fixed infrastructure of the cellular telecommunication system. The communication network 116 comprises a core network (CN) 114 representing a radio-independent layer of the communication network 116, and at least one radio access network (RAN) 104. The core network 114 may include network elements of different generations of cellular telecommunications systems. The radio access network 104 provides the user equipment 110 with radio interface using a radio access technology.

In the example shown in FIG. 1, the core network 114 is exemplified in terms of GSM terminology using both circuit-switched and packet-switched network elements. The packet-switched network elements are described in terms of a GPRS (General Packet Radio Service) system, which provides the user equipment 110 with access to external data networks over GSM and supports standard protocols, such as TCP (Transmission Control Protocol) and IP (Internet Protocol). The invention is not, however, restricted to the systems, division of systems, or protocols used in the system described in the examples, but can be applied to any cellular telecommunications system.

A centre 100 represents a mobile services switching centre (MSC) and a serving GPRS support node (SGSN) enabling circuit-switched and packet-switched signalling, respectively, in the cellular telecommunications system.

A function of the serving GPRS support node 100 is to transmit packets to and receive them from user equipment 110 supporting packet-switched transmission. The serving GPRS support node 100 includes subscriber information and location information about the user equipment 110.

The core network 114 may also have a gateway unit 102 representing both a gateway mobile service switching centre (GMSC) and a gateway GPRS support node (GGSN). The GMSC attends to the circuit-switched connections between the core network 114 and external networks (EXT) 124 such as a public land mobile network (PLMN) or a public switched telephone network (PSTN), and the GGSN attends to the packet-switched connections between the core network 114 and external networks 124 such as the Internet.

The centre 100 controls the radio access network 104, which may comprise at least one base station controller (BSC) 106 controlling at least one base station (BS) 108. The base station controller 106 may also be called a radio network controller, and the base station 108 may be called a node B.

The media stream 126 is broadcasted by the broadcast system 118. The media stream 126 may include, for example, a radio or television program, a commercial or an announcement. The media stream 126 may include speech, music, or pictures. The content of the media stream 126, however, is not relevant to the present solution.

A system according to an aspect of the invention further comprises a server (SERVER) 112 connected to the communication network 114 and the broadcast system 118 for providing the user equipment 110 with service 128 associated with the media stream by using the radio interface of the cellular telecommunication system. The server 112 may be a computer, such as a personal computer or a work station with interface to the communication network 114 and the broadcast system 118. The physical location of the server 112 is not relevant as far as required connections with external networks and equipment exist.

The user equipment 110 comprises a user terminal (UT) 120 for communicating in the cellular telecommunication system using a radio interface provided by the base station 108. The user equipment 110 further comprises a media receiver (MRX) 122, such as an FM receiver or a television receiver, for receiving a media stream 126 provided by the broadcast system 118.

The server 112 may be connected to the centre 100, the gateway unit 102, the radio access network 104, or other parts of the communication network 116. In an embodiment, the server 112 communicates with the communication network 116 over the radio interface of the cellular telecommunication system.

The base station 108 may communicate with the user equipment 110 using a GPRS method, which utilizes transferring data in packets that contain address and control data in addition to the actual data. Several connections may employ the same transmission channel simultaneously. The packet switching method is suitable for data transmission where the data to be transmitted is generated in bursts. In such a case, it is not necessary to allocate a data link for the entire duration of transmission but only for the time it takes to transmit the packets. This reduces costs and saves capacity considerably during both the set-up and the use of the communication network 116.

The server 112, for example, controls the content flow between the user equipment 110 and the communication network 1 16. The server 112 may also facilitate timed delivery of content of the service to the user equipment 110.

The service 128 provides the user equipment 110 with a communication channel parallel to the broadcast channel used in delivering the media stream 126 to the user. This is called a parallel channel operation. A logical address may be dedicated to the service 128 so that the service 128 may be accessed by using the logical address of a database (DB) 130 of the server 112. The database 130 of the service comprises computer files containing the service content. The content of the service may vary as a function of time and possibly as a function of the content of the media stream 126. The 128 service provides a bit stream to the user equipment 110, the bit stream including information content, such as graphical information, text information, audio information, a computer program, Braille, vibration, or any combination thereof. In an embodiment, the content of the service 128 is displayed on a display of the user equipment 110.

When the parallel channel software operation in the user equipment 110 is initiated, the user equipment 110 may transmit information about itself to the server 112, and the server 112 informs the user equipment 110 of the media stream 126. With the information about the user equipment 110, a specific variant of the content can be delivered, which contains graphics objects optimised to the capabilities and the screen size of each user equipment 110.

The service provider is a party possessing rights for relevant digital content of the service 128, a distribution system for providing the user equipment 110 with the service 128, and possibly capability to bill the user for the service 128. The service provider's delivery system is responsible for receiving and handling delivery requests and delivering the service 128 to the user equipment 110.

In the user equipment 110, the system provides an integrated user experience, allowing the user to start both listening to a media stream 116 and receiving the content of the service relating to the media stream 116. The operation of the media is based on two channels, the broadcast channel and the parallel channel enabled by the cellular telecommunication system. The media system, on the other hand, provides the visual and interactive parallel channel functionality, such as receiving and displaying content and reporting user interactions to the server 112.

In an embodiment, an association between a media stream 126 and a service 128 is based on a characterization of the service 128 and a characterization of the media stream 126. If there is a linkage between a characterization of the service 128 and a characterization of the media stream 126, the service 128 and the media stream 126 are deemed to be associated with each other. A media stream 126 may be associated with one or more services 128. A service 128 may be associated with one or more media streams 126.

The associating data is a piece of information providing a linkage between the media stream 126 and the service 128. In an explicit linkage, the associating data provides explicit characterization of both the media stream 126 and the service 128 so that by using the associating data, a desired media stream 126, such as a radio sports program, and a service 128, such as sports results relating to the program, can be delivered to the user equipment 110. In such a case, the associating data includes, for example, the frequency utilized by the radio broadcast and the address of the service 128 providing the sports results. The characterization may be, for example, a service identification or a radio channel identification. The characterization may specify content, such as sports content, of the service 128 or the media stream 126.

In an implicit linkage, the associating data includes information, which is used to provide the explicit characterization of the media stream 126 and the service 128. The implicit linkage requires that the explicit linkage be available to the user equipment somewhere in the system. The explicit linkage may be obtainable from the user equipment 110 based on the history of the user equipment 110, or from the service provider. For example, the associating data includes an identification of the radio station. In such a case, the identification may be fed into an association register, which returns the identification of the service 128 and possibly the frequency utilized by the media stream 126. The service identification may be used in configuring the user equipment 110, and the service 128 may be accessed by using the configuration. The associating register may be located in the user equipment 110 or the server providing the service 128, or anywhere in the system as long as the user equipment 110 may access the associating register.

The associating data may associate the media stream and the service on different levels depending, for example, on diversity of the service.

The associating data may include the following type of information: a radio service address, a service identification, an object identification, a radio broadcaster identification number, a program identification number, a traffic announcement identification number, a traffic program identification number, a program item number, an emergency warning message, a music/speech indicator, a radio frequency utilized by a media stream, a program service name, a programme type identification number, a country code, and location information.

In an embodiment, the system comprises a content creation tool (CCT) 132 connected to the server 112 and the broadcast system 118 for providing content for the service 128. The content creation tool 132, which can also be called a visual radio tool in some applications, may be used to create the service content presentation to be displayed on the user equipment 110. The content creation tool 132 may be located and integrated into the broadcast system 118.

The content creation tool 132 may allow a broadcast system to create a visual presentation and manage the content flow shown on the screen of the user equipment 110 in synchronization with the media stream 126.

The content creation tool 132 may also define timing to display the content of the service 128 in the user equipment 110 in relation to broadcast media stream timeline.

In an embodiment, the server 112 comprises an interaction engine (IE) 136 for forwarding service requests from the user equipment 110 to the service database 130 providing the requested service 128.

In an embodiment, the server 112 comprises a content delivery engine (CDE) 134 for delivering a signal with the content from the content creation tool 132 to the interaction engine 136 in the server 112, which sends the signal through the communication network 116 to the user equipment 110.

The exemplified broadcast system 118 comprises a timing information module (TIM) 138, a dynamic content delivery module (DCDM) 140, a broadcast content delivery module (BCDM) 142 and a user interface (UI) 144.

The broadcast content delivery module 142 transmits the media stream 126 to a media receiver 122, such as a radio receiver or a television receiver. The transmission may be implemented by using analogue or digital transmission. The transmission channel may be multiplexed with other channels by using frequency division, time division, code division, or a combination thereof.

The timing module 138 provides the server 112 with timing information on the time relationship between the media stream 126 and transmission of data stream from the server 112 to the user equipment 110. The timing module 138, for example, provides information on the starting time and the ending time of a particular program broadcast by the broadcast system 118, as well as information on timing of advertising breaks or related time structure in the media stream 126.

The user equipment 110 may comprise conventional components, including wireless modems, processors with software, memory, user interface, and display. The structure of the media receiver 122 and the user terminal 120 are known to a person skilled in the art.

The user equipment 110 may further include a specific software module for creating a parallel channel experience composed of the media stream 126 and the service 128. The software module may be implemented using a native operating system, such as Symbian, or using a programming environment, such as Java MIDP (Mobile Information Device Profile).

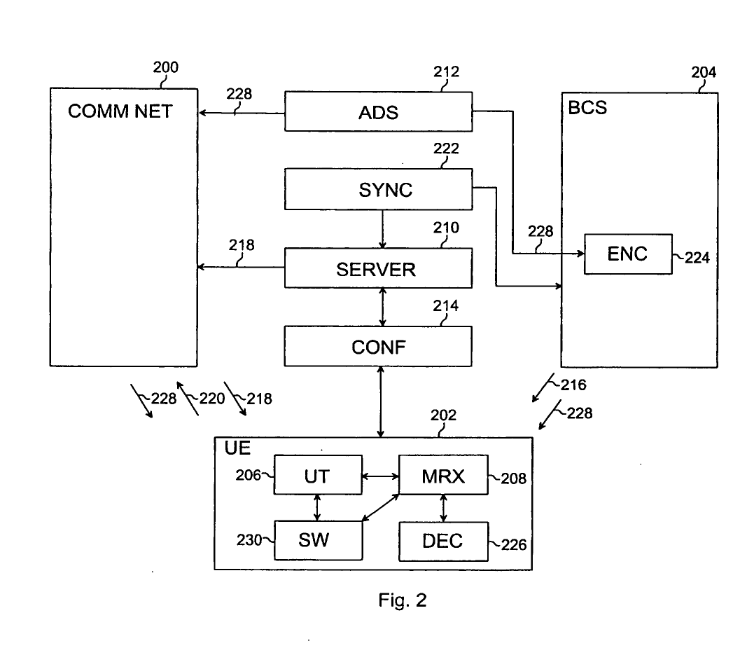

FIG. 2 shows a simplified structure of a system comprising a communication network 200, a broadcast system 204, a server 210, and user equipment 202. The user equipment 202 may utilize a return channel 220, such as a channel provided by the GPRS method, in delivering any information, including information on the associating data, requests and user identification, to the communication network 200. The structure and the functions of the elements of the system shown in FIG. 2 correspond to those represented in FIG. 1.

According to the second aspect of the invention, the system further comprises an associating data source 212 for providing the user equipment 110 with associating data 228 for associating the media stream 216 with the service 218. The associating data source 212 may be a register located in the server 110, the communication network 200, or the broadcast system 204.

According to the second aspect of the invention, the system further comprises configuring means 214 operationally connected to the user equipment 202 and the server 210 for configuring the system to provide the user equipment 202 with the service 218 associated with the media stream 216 by using the associating data 228.

In an embodiment, the system comprises a synchronizer 222 for synchronizing the service 216 with a media stream 218. The synchronizer 222, for example, obtains a starting time and advertising break information from the timing information module 124 of the broadcast system 118. In addition, the synchronizer 222 may provide the means for the user equipment 110 to synchronize their clocks with broadcast system time references by running a synchronization algorithm with the server 112. A synchronization algorithm may be based on calculating round trip delays of requests sent to the server 112 from the user equipment 110 and calculating the difference between the user equipment clock and the server clock. Once the user equipment 110 has performed synchronization and the starting time of the media stream is known, media stream timeline references can be translated to references in the internal clock of the user equipment 110. The content of the service 218 may be shown to the user in synchronization with the broadcast.

In an embodiment, at least a portion of the configuring means 214 is located in the user equipment 202. The configuring means 214 may be a software package 230 or a register, which configures the user equipment 202 with configuration parameters, such as an identification of the service 218, with which identification the user equipment 202 may access, for example, a specific file in the server 210.

In an embodiment, the configuration means 214 includes information based on the usage history of the user equipment 202. For example, the configuration means 214 is a register in the user equipment 202 including mapping between a service identification and a radio program identification number. If the associating data includes the radio program identification number, the user equipment 202 is capable of obtaining the service identification using the mapping and accessing the service 218 by using the service identification. The mapping may exist between any information characterizing a media stream 216 and a service 218. The mapping may be performed by the software package 230.

In an embodiment, at least a portion of the configuring means 214 is located in the server 210, the communication network 200, or the broadcast system. The tasks the configuring means 214 perform include: setting parameters in the server 112 so that data packets containing content of the service 218 are routed from the server 210 to the user equipment 202. The routing involves information on the address of the user equipment 202, which address is available, for example, from the serving GPRS support node 100. Routing procedures, for example in a GPRS system, are known to a person skilled in the art.

In an embodiment the associating data source 212 is connected to the broadcast system 204, the broadcast system 204 is arranged to transmit at least a portion of the associating data 228, and the media receiver 208 is arranged to receive at least the portion of the associating data 228. The data transfer may be based on analogue or digital data transfer. The associating data 228 may be for example one of those listed above.

In an embodiment, the associating data 228 includes an identification of the service using by which the service 218 can be accessed. Using the broadcast system 204 in delivering the associating data to the user equipment 202 provides an inexpensive way in data transfer while the capacity of the communication network 200 is not altered.

In an embodiment, the system comprises an encoder 224 connected to the broadcast system 204 for encoding at least a portion of the associating data 228 into the media stream 216, and the user equipment 202 comprises a decoder 226 connected to the media receiver 208 for decoding at least the portion of the associating data from the media stream 216. The associating data 228 may be encoded into the media stream 216 using an RDS (Radio Data System) standard available to public. The RDS enables transmitting information from the broadcast system 204 to media receivers in digital form such that the media receiver 208 is capable of, for example, displaying the information to the user or tuning the radio transceiver to a desired radio station. The RDS standard defines the structure of the data embedded in the media stream 216. A portion of the data is dedicated to predefined purposes, such as identification of the media stream. A portion of the data may be fed by, for example, the user interface 144 of the broadcast system. The advantages of using the RDS are several. The RDS enables a data transfer using existing tools in the radio broadcast system 204.

In an embodiment, the associating data source 212 is connected to the communication network 200, the communication network 200 is arranged to transmit at least a portion of the associating data 218; and the user terminal 206 is arranged to receive the at least a portion of the associating data 218. The associating data source 212 may be connected, for example, to the centre 100 to which a data packet including the associating data is transmitted from the associating data source 212. The data packet is transmitted by the base station 108 and received by the user terminal 206. The communication network 200 provides a flexible way of delivering the associating data to the user equipment due to, for example, high data rate and standardized data transfer protocols.

In an embodiment, the user equipment 202 is arranged to exchange associating data between the user terminal 206 and the media receiver 208. In embodiments of the invention, the associating data may be received by the user terminal 206 or the media receiver 208. For example, the media receiver 208 receives an IP address of the service, and transfers the IP address to the user terminal 206 so that the user terminal 206 can fetch the service 218 from the IP address. In an embodiment, the user terminal 206 receives a radio station identification and transfers the radio station identification to the media receiver 208. In an embodiment, the media receiver 208 is arranged, for example by using the radio station identification or a frequency utilized in the radio broadcast, to receive the media stream 216 associated with the service 218. The associating data exchange enables an efficient way to configure the system, since there is no need to transfer information between the user terminal 206 and the media receiver 208 by the user.

In an embodiment, the user equipment 202 is configured to store automatically at least a portion of the associating data, and the configuring means 214 are arranged to configure the system by using the portion of the associating data. The automatic storing enables an easy way to configure the system since there is no need to memorize associating data by the user.

In an embodiment, the user terminal 206 is arranged to transmit at least a portion of the associating data to the server 218, and the server 218 is arranged to provide the user equipment 202 with the service 218 by using at least the portion of the associating data. The user equipment 202 may have received an IP address of the service 218, with which the service 218 is accessed.

In an embodiment, the user terminal 206 is arranged to request for configuration parameters for configuring the user equipment 206 to access the service 218, by using at least a portion of the associating data, the server 218 is arranged to return the configuration parameters; and the configuring means 214 are arranged to configure the user equipment 202 with the configuration parameters. By requesting for the configuration parameters, the user equipment 202 has access to updated information on the system and allows for small information content to the associating data. The configuration parameters may carry information on the following: a radio service address, a service identification, an object identification, a radio broadcaster identification number, a program identification number, a traffic announcement identification number, a traffic program identification number, a program item number, an emergency warning message, a music/speech indicator, a radio frequency utilized by a media stream, a program service name, a programme type identification number, a country code, and location information. The user equipment 202 may, for example, transmit a radio broadcaster identification number to the server 210, which returns a radio frequency utilized in broadcasting the media stream 216 and an object identification to the user terminal 206. The radio frequency providing the media stream 216 and the object identification may be stored in the user equipment 202 such that the object provided by the service 218 associated with the media stream 216 may be accessed in an easy manner by using, presets for example.

In an embodiment, the user equipment 202 is arranged to display at least a portion of the associating data to the user, the user equipment 202 is arranged to register a selection of an item from at least the portion of the associating data, and the configuring means 214 are arranged to configure the system by using the item. The associating data may include, for example, program service names presenting the name of the radio stations available to the media receiver 208. A list of the program service names may be shown to the user on a display of the user equipment 202, from which the user may select an item. The selected item is registered by the user equipment 202. The item may also include the service identification. The items may be stored in presets of the user equipment 202 for later use. In an embodiment, the user selects items, which are transmitted to the server 210. The server 210 returns more specific information, such as service identification and radio frequencies in order to provide configuration parameters to be used in configuring the user equipment 202 to access the service 218 and the associated media 216. The configuration may include configuring presets in the user interface of the user equipment 202. The presets may present any information that characterizes the service 218 and the media stream 216.

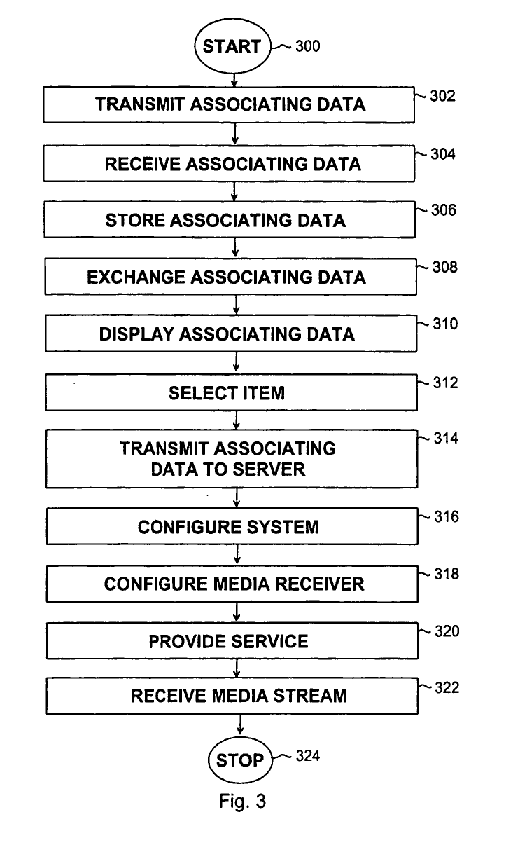

With reference to FIG. 3, 4 and 5, embodiments of the first aspects of the invention are shown.

In FIG. 1, the method is started in 300. The associated data is transmitted in 302. The associating data is received in 304. A portion of the associating data is stored in 306. A portion of the associating data is exchanged between the user terminal 206 and the media receiver 208 in 308. A portion of the associating data is displayed in 310. An item is selected from the associated data displayed in 312. A portion of the associating data is transmitted to the server 210 in 314. The system is configured using the associating data in 316. The media receiver 208 is configured using the associating data in 318. The service 218 is provided in 320. A portion of the media stream 216 is received in 322. The method is stopped in 324.

In FIG. 2, the method is started in 400. The associated data is transmitted in 402. The associating data is received in 404. The configuration parameters are requested for in 406. The configuration parameters are returned in 408. The system is configured by using the configuration parameters in 410. The method is stopped in 412.

In FIG. 3, the method is started in 500. In 502, the associating data is encoded into the media stream 216. In 504, the associating data is transmitted from the broadcast system 204. In 506, the associating data is received in the media receiver 208. In 508, the associating data is decoded from the media stream 216. In 510, the system is configured. In 512, the method is stopped.

It is to be understood that other embodiments may be utilized and structural and functional modifications may be made without departing from the scope of appended claims.

1. A method of providing a service for user equipment of a cellular telecommunication system, the service being transmitted over a radio interface of a cellular telecommunication system, the user equipment comprising a user terminal for communicating in the cellular telecommunication system and a media receiver for receiving a media stream provided by a radio broadcast system, the method comprising:
transmitting associating data for associating a media stream with a service;
receiving, in the user equipment, the associating data; and
configuring a system comprising the cellular telecommunication system and the broadcast system to provide the user equipment with the service associated with the media stream by using the associating data.

2. The method according to claim 1, further comprising:
storing automatically at least a portion of the associating data in the user equipment; and
configuring the system by using the at least a portion of the associating data.

3. The method according to claim 1, further comprising providing the user equipment with the service using the associating data.

4. The method according to claim 1, further comprising configuring the media receiver to receive a media stream associated with the service.

5. The method according to claim 4, further comprising receiving the media stream.

6. The method according to claim 1, further comprising transmitting the associating data for associating a media stream with a service synchronized with the media stream.

7. The method according to claim 1, further comprising transmitting associating data including at least one of the following:
a service identification
a radio service address
a radio broadcaster identification number
a programme identification number
a traffic announcement identification number
a traffic programme identification number
a programme item number
an emergency warning message
a music/speech indicator
a radio frequency utilized by a media stream
a programme service name
a programme type identification number
a country code
location information

8. The method according to claim 1, further comprising:
transmitting at least a portion of the associating data from the user equipment to a server providing the service for user equipment; and
configuring the server to provide the user equipment with the service by using the at least a portion of the associating data.

9. The method according to claim 1, further comprising:
requesting for configuration parameters for configuring the user equipment to access the service, by using at least a portion of the associating data;
returning the configuration parameters; and
configuring the user equipment with the configuration parameters.

10. The method according to claim 9, further comprising returning configuration parameters including at least one of the following:
a service identification
a radio service address
a radio broadcaster identification number
a programme identification number
a traffic announcement identification number
a traffic programme identification number
a programme item number
an emergency warming message
a music/speech indicator
a radio frequency utilized by a media stream
a programme service name
a programme type identification number
a country code
location information

11. The method according to claim 1, further comprising:
displaying at least a portion of the associating data to the user;
selecting an item from the at least a portion of the associating data by the user; and
configuring the system by using the item.

12. The method according to claim 1, further comprising:
transmitting at least a portion of the associating data using the broadcast system; and
receiving at least a portion of the associating data using the media receiver.

13. The method according to claim 1, further comprising transmitting at least a portion of the associating data using the cellular telecommunication system.

14. The method of claim 1, further comprising:
encoding at least a portion of the associating data into the media stream; and
decoding, in the user equipment, the at least a portion of the associating data from the media stream.

15. The method of claim 1, further comprising exchanging associating data between the media receiver and the user terminal.

16. A system or providing a service for user equipment, comprising:
a communication network of a cellular telecommunication system for providing the user equipment with mobile services; a broadcast system for providing the user equipment with a media stream;
a user terminal, in the user equipment, for communicating in the cellular telecommunication system; and
a media receiver, in the user equipment, for receiving the media stream;
a server connected to the communication network for providing the user equipment with service associated with the media stream by using the radio interface of the cellular telecommunication system;
an associating data source for providing the user equipment with associating data for associating the media stream with the services;
wherein the user equipment is configured to receive at least a portion of the associating data; the system further comprising
configuring means operationally connected to the user equipment and the server for configuring the system to provide the user equipment with the service associated with the media stream by using the associating data.

17. The system according claim 16, wherein
the user equipment is configured to store automatically at least a portion of the associating data; and
wherein the configuring means are arranged to configure the system by using the portion of the associating data.

18. The system according to claim 16, wherein the server is arranged to provide the user equipment with the service using the associating data.

19. The system according to claim 16, wherein the media receiver is arranged to receive the media stream associated with the service.

20. The system according to claim 16, wherein the system comprises a synchronizer connected to the serve and the broadcast system for synchronizing the service with the media stream; and
wherein the associating data source is arranged to provide the associating data for associating the media stream with a service synchronized with the media stream.

21. The system according to claim 16, wherein the associating data source is arranged to provide associating data including at least one of the following:
a service identification
a radio service address
a radio broadcaster identification number
a programme identification number
a traffic announcement identification number
a traffic programme identification number
a programme item number
an emergency warning message
a music/speech indicator
a radio frequency utilized by a media stream
a programme service name
a programme type identification number
a country code
location information

22. The system according to claim 16, wherein the user terminal is arranged to transmit at least a portion of the associating data to the server; and
wherein the server is arranged to provide the user equipment with the service by using the at least a portion of the associating data.

23. The system according to claim 16, wherein the user terminal is arranged to request for configuration parameters for configuring the user equipment to access the service, by using at least a portion of the associating data;
wherein the server is arranged to return the configuration parameters; and
wherein the configuring means are arranged to configure the user equipment with the configuration parameters.

24. The system according to claim 23, wherein the server is arranged to return configuration parameters including at least one of the following:
a service identification
a radio service address
a radio broadcaster identification number
a programme identification number
a traffic announcement identification number
a traffic programme identification number
a programme item number
an emergency warning message
a music/speech indicator
a radio frequency utilized by a media stream
a programme service name
a programme type identification number
a country code
location information

25. The system according to claim 16, wherein the user equipment is arranged to display at least a portion of the associating data to the user;
wherein the user equipment is arranged to register a selection of an item from the at least a portion of the associating data; and
wherein the configuring means are arranged to configure the system by using the item.

26. The system according to claim 16, wherein the associating data source is connected to the broadcast system;
wherein the broadcast system is arranged to transmit at least a portion of the associating data; and
wherein the media receiver is arranged to receive the at least a portion of the associating data.

27. The system according to claim 16, wherein the associating data source is connected to the communication networks;
wherein the communication network is arranged to transmit at least a portion of the associating data; and
wherein the user terminal is arranged to receive the at least a portion of the associating data.

28. The system according to claim 16, wherein the system comprises an encoder connected to the broadcast system for encoding at least a portion of the associating data into the media stream; and
wherein the user equipment comprises a decoder connected to the media receiver for decoding the at least a portion of the associating data from the media stream.

29. The system according to claim 16, wherein the user equipment is arranged to exchange associating data between the user terminal and the media receiver.
